(19) United States
(12) Patent Application Publication
(10) Pub. No.: US 2007/0009409 A1
(43) Pub. Date: Jan. 11, 2007

(54) 212Bi or 213Bi Generator from supported parent isotope

(76) Inventors: Hariprasad Gali, College Station, TX (US); Alan J. Cisar, Cypress, TX (US)

Correspondence Address: STREETS & STEELE, 13831 NORTHWEST FREEWAY, SUITE 355, HOUSTON, TX, 77040, US

(21) Appl. No.: 11/178,741

(22) Filed: Jul. 11, 2005

(51) Int. Cl. C01F 13/00

(52) U.S. Cl. 423/2

(57) ABSTRACT

The invention includes a radionuclide generator having an ion exchange sorbent that comprises oxygen-containing functional groups grafted by organic linking groups to an inorganic oxygen-linked network and a parent isotope. For ²¹²Bi or ²¹³Bi generators, the parent isotope may be ²²⁴Ra, ²²⁵Ra or ²²⁵Ac. The surface area of the sorbent is preferably less than about 10 m²/g and more preferably less than about 1 m²/g. The exchange sorbent may be formed of any covalently bonded inorganic oxide that is capable of forming oxygen-linked networks. The oxidized functional groups may include sulfonato groups, may include moieties selected from —SO₃H, —SO₃Na, —SO₃K, —SO₃Li, —SO₃NH₄ or may include moieties selected from —PO(OX)₂ or —COOX, wherein X is selected from H, Na, K or NH₄ or combinations thereof. A ²¹³Bi or ²¹²Bi generator process includes eluting ²¹³Bi or ²¹²Bi with an aqueous solvent that includes ²²⁵Ac or ²²⁵Ra or ²²⁴Ra on the above support medium.

### BACKGROUND OF THE INVENTION

1. Field of the Invention

The present invention relates to radionuclide generators, ion exchange materials for radionuclide generators and methods of making these materials.

2. Description of the Related Art

The use of alpha-emitting radionuclides in the treatment of specific forms of cancer has become increasingly of interest in recent years. Alpha particles are far more effective in the destruction of cancer cells than gamma or beta particles due to their greater linear energy transfer (LET) rates. ²¹²Bi and ²¹³Bi have been identified as important radioisotopes for use in this new field of nuclear medicine.

In order for an isotope to be used in medical applications, the isotope should be of high purity to avoid introduction of other, undesirable, radioactive isotopes into the body that would deliver an unnecessary dose to sensitive areas of the body such as the bone marrow. ²¹³Bi is produced as a daughter product in the decay of ²²⁹Th, which is a daughter product of the decay of ²³³U. ²¹³Bi has a short half-life of only about 45 minutes, which means that it rapidly decays away once introduced into the body. The decay series that includes ²¹³Bi is shown in FIG. 1. ²¹²Bi, with a half-life of about 60 minutes, forms part of the decay chain of ²²⁸Th, which is a daughter product of ²³²U. The decay series that includes ²¹²Bi and ²¹²Pb is shown in FIG. 2.

²²⁵Ac or ²²⁴Ra (for ²¹³Bi) and ²²⁴Ra (for ²¹²Bi) are parent isotopes of choice that can be immobilized and shipped to medical facilities to provide ²¹²Bi and ²¹³Bi at their point of use. However, alpha particles produced in the decay chain are extremely destructive towards conventional organic ion exchange resins, leading to limited generator life, bleeding of undesirable ²²⁵Ac, ²²⁵Ra, ²²⁴Ra or ²¹²Pb into the ²¹²Bi or ²¹³Bi product and the possible release of pyrogenic decomposition products from radiation damage to the resin into the aqueous phase during elution.

There is a need to provide a robust generator of these useful isotopes. A useful generator would provide an ion exchange material on which the parent isotope and intermediate daughters between the parent and the desired daughter may be immobilized. The ion exchange material must be capable of withstanding bombardment by the destructive alpha particles, as well as other particles, released during the production of the useful isotopes without significant deterioration. Furthermore, the ion exchange material must allow the useful isotope to be eluted when needed but still retain the parent isotope in an immobile form.

Therefore, there is a need for a radionuclide generator, such as a ²¹²Bi or ²¹³Bi generator that has improved stability against alpha particles and other forms of ionizing radiation. It would be desirable if the generator provided high separation and high stability in order to yield an eluate solution having substantially no parent isotope and no by-products of generator decomposition.

### SUMMARY OF THE INVENTION

The present invention provides methods for making, processes for using and radionuclide generators that are useful for generating, inter alia, ²¹²Bi and ²¹³Bi. In a particular embodiment of the present invention that provides a radionuclide generator, the generator includes an ion exchange sorbent comprising oxygen-containing functional groups grafted by organic linking groups to an inorganic oxygen-linked network. The surface area of the exchange sorbent is less than about 100 m²/g, preferably less than about 10 m²/g and more preferably less than about 1 m²/g. The generator may further include a parent isotope adsorbed onto the exchange sorbent, wherein the parent isotope is selected from ²²⁴Ra or ²²⁵Ra. In particular embodiments of the present invention, the parent isotope for a ²¹³Bi generator may include ²²⁵Ac.

The exchange sorbent may be formed of any covalently bonded inorganic oxide that is capable of forming oxygen-linked networks. The inorganic oxygen-linked network may include oxides of aluminum, titanium, silica, zirconium, hafnium, tantalum, niobium, germanium, gallium, tin, antimony or combinations thereof. In particular embodiments of the present invention, the inorganic oxygen-linked network comprises silica while other embodiments include an inorganic oxygen-linked network that includes essentially no silica.

The oxygen-containing functional groups of the exchange sorbent may include sulfonato groups. In particular embodiments, the function groups may include moieties selected from —SO₃H, —SO₃Na, —SO₃K, —SO₃Li or combinations thereof. The functional groups may further include moieties selected from —PO(OX)₂ or —COOX, wherein X is selected from H, Na, K, NH₄ or a combination of these.

In particular embodiments of the present invention, the ion exchange sorbent may be amorphous. The linking group may be an organic moiety such as, for example, an organic chain having between about 1 and about 10 carbon atoms or preferably, between about 2 and about 4 carbon atoms.

In particular embodiments of the present invention, the exchange sorbent is functionalized between about 1 and about 80 percent or preferably, between about 1 and about 25 percent. The functionalized percent of the exchange sorbent is the ratio of the number of moles of the functional groups to the total number of moles of both the inorganic species of the exchange sorbent and the functional groups, expressed as a percent. The diameter of the particles of the exchange sorbent in particular embodiments may be between about 75 μm and about 150 μm.

Particular embodiments of the present invention may further provide a ²¹³ Bi generator process that includes eluting an eluate solution of ²¹³Bi with an aqueous solvent from a generator that includes ²²⁵Ac or ²²⁵Ra on a support medium, wherein the support medium is an exchange sorbent comprising oxygen-containing functional groups grafted by organic linking groups to an inorganic oxygen-linked network and wherein a surface area of the exchange sorbent is less than about 100 m²/g, preferably less than about 10 m²/g and more preferably less than about 1 m²/g.

The aqueous solvent may include an aqueous acid having a concentration of between about 0.01 M and about 2 M and preferably between about 0.1 M and about 0.5 M. The aqueous acid may be selected, for example, from HCl, HI, HBr or combinations thereof. The aqueous solvent may include HI having a concentration of between about 0.1 M and 0.5 M.

Particular embodiments of the present invention may further provide a ²¹²Bi generator process that includes eluting an eluate solution of ²¹²Bi using an aqueous solvent from a generator that includes a support medium previously loaded with ²²⁴Ra and/or it's daughters, wherein the support medium is an exchange sorbent comprising oxygen containing functional groups grafted by an organic linking group to an inorganic oxygen-linked network, wherein a surface area of the exchange sorbent is less than about 100 m²/g, preferably less than about 10 m²/g and more preferably less than about 1 m²/g.

Embodiments of the present invention may further include methods for making a radionuclide generator. Particular embodiments may include methods for making a radionuclide generator for ²¹²Bi or ²¹³Bi that include the step of loading a parent isotope onto an exchange sorbent comprising oxygen-containing functional groups grafted by organic linking groups to an inorganic oxygen-linked network, wherein a surface area of the exchange sorbent is less than about 100 m²/g. The parent isotope may include ²²⁵Ac, ²²⁵Ra or ²²⁴Ra.

Steps for synthesizing the exchange sorbent may include combining an inorganic species with a functionalized silane in a solution comprising an alcohol and an acid to form a reaction mixture and mixing the reaction mixture. The method may further include evaporating the reaction mixture to recover a functionalized inorganic oxygen-linked network product and oxidizing the functional groups. The moles of functionalized silane in the reaction mixture may be between about 1% and about 80% of the total moles of the functionalized silane and the inorganic species.

The acid in the solution may include HCl, HNO₃, H₂SO₄, HBr, HI or combinations thereof. The alcohol in the solution may include ethanol, butanol, propanol, isopropanol, isomers of butanol or combinations thereof. The functionalized silane may be 3-mercaptopropyltrimethoxy silane.

Particular embodiments of the present invention may further include steps for synthesizing the exchange sorbent including combining an alkoxide-containing inorganic species with a silicon-containing thiol species in a solution comprising an alcohol and a mineral acid to form a reaction mixture and mixing the reaction mixture. Other steps may include evaporating the reaction mixture to recover a functionalized inorganic oxygen-linked network product and oxidizing the functional groups.

Other embodiments of the present invention may include steps for synthesizing the exchange sorbent including combining an alkoxide-containing inorganic species with a silicon-containing thiol species in a solution comprising an alcohol and a base to form a reaction mixture, evaporating the reaction mixture to recover a functionalized inorganic oxygen-linked network product and oxidizing the functional groups. The base may be, for example, ammonium hydroxide.

Still further embodiments of the present invention may include steps for synthesizing the exchange sorbent including combining an alkoxide containing inorganic species with a silicon-containing sulphonic acid species in a solution comprising an alcohol to form a reaction mixture, mixing the reaction mixture and evaporating the reaction mixture to recover a functionalized inorganic oxygen-linked network product. The solution of the reaction mixture may further comprise a mineral acid.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematic drawing of the ²²⁹Th decay chain.

FIG. 2 is a schematic drawing of the ²²⁸Th decay chain.

FIG. 3 is a schematic drawing of an exemplary synthesis of sulfonato-functionalized silica.

FIG. 4 is a bar graph showing the binding affinity of a sulfonato-functionalized exchange sorbent for non-radioactive surrogates.

FIGS. 5A-5E are graphs of the experimental results obtained from ion exchange column studies using a sulfonato-functionalized silica exchange sorbent.

FIG. 6 is a graph of the experimental results obtained from ion exchange column studies using sulfonato-functionalized silica exchange sorbent and ²²³Ra.

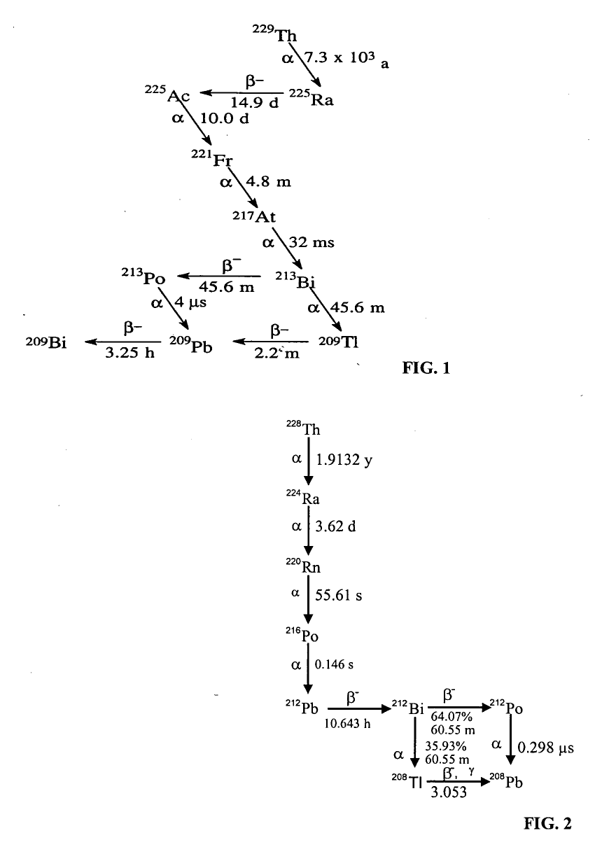

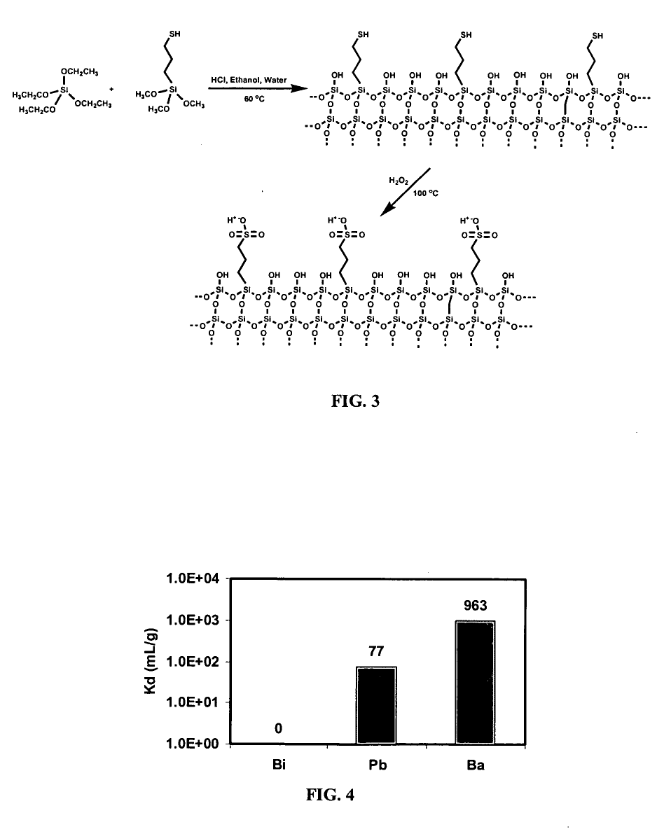

### DETAILED DESCRIPTION

The present invention provides various embodiments that include a generator for either ²¹²Bi or ²¹³Bi and methods for making an ion exchange sorbent useful in the generator. The generator, under selected controlled conditions, is highly selective for ²²⁵Ac, ^{224/225}Ra, and ²¹²Pb, which are all effectively retained on the sorbent during elution with an aqueous solution but is non-selective for ²¹²Bi or ²¹³ Bi, which are not retained but are released into the aqueous solution.

The ion exchange sorbent useful in ²¹²Bi or ²¹³Bi generators includes functionalized species, such as sulfonato-functionalized silicas, useful for the recovery of ²¹²Bi or ²¹³Bi from the decay of ²²⁵Ac or ^{224/225}Ra. These exchange sorbents are hydrophilic acid cation exchange materials that are an inorganic-organic hybrid having an inorganic backbone structure. The inorganic backbone structure makes these exchange sorbents highly resistant to damage from ionizing radiation. Consequently, ²²⁵Ac and/or ^{224/225}Ra may be loaded onto the exchange sorbent and the decay product, ²¹²Bi or ²¹³Bi eluted as required.

A preferred embodiment includes the sulfonato-functionalized silicas. In some embodiments of the present invention, some or all of the silica that forms the inorganic backbone or support of the exchange sorbent may be replaced by other species capable of forming oxygen-linked networks, such as, for example, aluminum, titanium and zirconium. A preferred embodiment includes an ion exchange sorbent that is amorphous although such structure is not required.

In an embodiment of sulfonato-functionalized silicas of the present invention, sulfonic acid groups (—SO₃H) are covalently linked to a hydrophilic silicate support to form an inorganic-organic hybrid exchange sorbent. Examples of ions other than the proton present in the sulfonic acid group that may be exchanged onto the sulfonato (—SO₃⁻) functionality to form a suitable ²¹²Bi or ²¹³Bi generator include, for example, sodium (—SO₃Na), potassium (—SO₃K), and lithium (—SO₃Li). Such substitutions may be used alone or in combination. The functional groups may be grafted to the support species to form a functionalized species that is functionalized between about 1 and about 80 percent and preferably between about 10 and about 50 percent. The definition of the functionalized percent of the exchange sorbent is the ratio of the number of moles of the functional groups to the total number of moles of both the inorganic monomer species of the exchange sorbent and the functional groups, expressed as a percent.

The functional group may be grafted to a silane or other inorganic support species by a linking group that is typically an alkyl, alkylene, aryl or alkyne group or some combination of these groups. Linking groups may further include chains having more than one carbon-carbon double or triple bond. The linking group may be a chain that includes from one to 20 carbons, preferably, from 1 to 10 and most preferably from two to four carbon atoms. Preferably, the linking group is a straight chain but the invention is not limited to straight chains. Branched chains and cyclic attachment groups are within the scope of the present invention. Some of the carbon atoms may be replaced with heteroatoms.

The hydrophilic exchange sorbent provides efficient diffusion of the parent metal ions from an aqueous solution used to load the generator due to reduced external mass transfer resistance. While not limiting the invention, it is believed that this reduced mass transfer resistance is responsible for the high binding constants and very fast kinetics shown by these materials. Furthermore, this characterization of the sulfonato-functionalized silicas enables small volumes of the hybrid inorganic-organic exchange material to elute the ²¹²Bi or ²¹³Bi from a generator using only a small volume of eluant to produce a high specific activity ²¹²Bi or ²¹³Bi product for use in radiopharmaceutical preparations.

In one embodiment, a hybrid inorganic-organic cation exchange sorbent is made by reacting a functionalized silane, or other suitable inorganic species capable of forming oxygen linked networks, with organo-silicate to form a functionalized silica. Useful organo-silicates include, for example, tetraethylorthosilicate and similar silicon alkoxides. In a preferred embodiment, compounds useful for synthesizing thiol-functionalized silica include tetraethylorthosilicate and 3-mercaptopropyl-trimethoxy silane (a functionalized silane). The mole ratio of silane to silicate may range between about 0.01 and about 33, preferably between about 0.01 and 9. Other examples of useful functionalized silanes include, for example, mercaptomethylmethyldiethoxysilane, 3-mercaptopropylmethyldiethoxysilane, 3-mercaptopropyltriethoxysilane, 2-(4-chlorosulfonylphenyl)ethyltrichlorosilane, 2-(4-chlorosulfonylphenyl)ethyltrimethoxysilane, N-(trimethoxysilylpropyl)ethylenediamine triacetic acid, 2-cyanoethyltrimethoxysilane, 3-diethylphosphonatopropyltriethoxysilane, and 3-chloropropyltrimethoxysilane.

In an embodiment of the present invention further disclosed below, the thiol-functionalized silane reactant may be replaced with a sulfonic acid such as, for example, 3-(trihydroxysilyl)-1-propanesulfonic acid. In addition, cyano (—CN) groups can be converted to carboxylate groups (—COOH) groups by an oxidation reaction after formation of cyano-functionalized silica. Phosphonate groups can be converted to phosphonic acid (—PO(OH)₂) groups by hydrolysis with a mineral acid at high temperature. In a similar manner, chloro groups in a chloro-functionalized silica can be converted to phosphonic acid (—PO(OH)₂) groups by reaction with triethylphosphate at high temperature followed by hydrolysis with a mineral acid at high temperature.

The reaction of the organo-silicate with the silane yielding the thiol-functionalized silica proceeds in the presence of an acid or a base, water and an alcohol at room temperature. The acid-catalyzed reaction produces a material with significantly lower surface area when compared to that produced by a base catalyzed reaction with the same amount of thiol-functionalization. Since low surface area is a desired characteristic of the exchange sorbent, embodiments of the present invention that utilize an exchange sorbent synthesized with an acid catalyzed reaction are preferred. Acid catalyzed exchange sorbent has been synthesized with a surface area of less than about 50 m²/g compared to a surface areas greater than 300 m²/g obtained with base-catalyzed exchange sorbent. While the low surface area acid-catalyzed product has been found to be most effective for the generator application disclosed here, the high surface area material produced by base catalysis has applications where high sorptive capacity is the primary goal.

Acids useful for catalysis of the synthesis reaction may be selected from strong acids or mixtures thereof, preferably mineral acids such as hydrochloric (HCl) nitric (HNO₃), sulfuric (H₂SO₄), hydrobromic (HBr), hydroiodic (HI) and combinations of these and other mineral acids. The alcohol may be selected from ethanol and others, such as, for example, propanol and isopropanol (both C₃H₇OH), methanol (CH₃OH), butanol and its isomers (C₄H₉OH) and combinations of these and other alcohols. A preferred acid is HCl and a preferred alcohol is ethanol. In one embodiment, the reactants are combined with the HCl, water and ethanol and then vigorously mixed for between about 1 and about 30 minutes, preferably about 5 minutes. The solvents are then evaporated and the remaining thiol-functionalized silica is ground, sieved and washed with a strong acid before being processed further, dried, or used as obtained product.

To convert the thiol-functionalized silica to the cation exchange sorbent of an embodiment of the present invention, the thiol-functionalized silica is oxidized to convert the thiol functional groups to sulfonic acid groups by mixing the thiol-functionalized silicates with an oxidizer. A preferred oxidizer is hydrogen peroxide. Alternatively, any suitable oxidizer may be used for the oxidation step as known to those having ordinary skill in the art, such as using ozone alone or in the presence of an iron catalyst or UV light.

Preferably, the thiol functionalized silica particles are suspended in 30% hydrogen peroxide for a period of between about 10 minutes and about 60 minutes and most preferably for about 20 minutes to provide the optimal oxidation of the thiol functional groups to the sulfonic acid groups. During the oxidation step, the suspended particles are slowly stirred while the suspension of particles is heated to about 100° C. Of course, if the strength of the hydrogen peroxide or alternative oxidizer is changed, then the optimal time for the oxidation step will increase or decrease based upon the amount of available oxygen in the changed peroxide or oxidizer concentration. The amount of 30% hydrogen peroxide used in the oxidation step is preferably between about 1 and about 20 mL/g of material to be oxidized and more preferably between about 3 and about 7 mL/g of material to be oxidized.

After the particles are oxidized to yield the desired functionalized species, such as the sulfonato-functionalized silica, the particles are washed with deionized water, then washed with a strong acid to fully protonate the exchange sorbent, washed again with deionized water and then dried and stored. The strong acid may be, for example, any strong mineral acid, such as hydrochloric acid, sulfuric acid, nitric acid or combinations thereof. If desired, the resulting ion exchanger may be exchanged into other ionic forms following methods known to those skilled in the art. Versions of this material with the protons replaced by other simple ions (i.e., sodium, potassium or lithium) to provide, for example, —SO₃Na, —SO₃K, —SO₃Li, or —SO₃NH₄ are considered to be within the scope of this invention.

In another embodiment of this invention, the mineral acid used to catalyze the hydrolysis can be replaced, either totally or partially, with a silicon-containing sulfonic acid, such as 3-(trihydroxysilyl)-1-propanesulfonic acid or with a mixture of the silicon-containing sulfonic acid and one of the mineral acids disclosed above. Use of the silicon-containing sulfonic acid as a reactant in the synthesis of the exchange sorbent replaces the thiol-functionalized silane as a reactant. In this embodiment the sulfonic acid, either alone or in combination with the mineral acid, catalyzes the condensation reaction with the silicate. The hydroxyl groups on the silicate serve as polymerization sites, making the sulfonic acid part of the framework, with the sulfonate functionality of the acid, available for ion exchange.

In another embodiment, a hybrid inorganic-organic cation exchange sorbent is made by reacting a suitable inorganic species capable of forming oxygen linked networks, with a functionalized organo-silane to form a functionalized silica. Useful inorganic-silicates include, for example, sodium silicate and similar silicates. Some examples of useful functionalized silanes include, for example, mercaptomethylmethyldiethoxysilane, 3-mercaptopropylmethyl-diethoxysilane, 3-mercapto-propyltriethoxysilane, 2-(4-chlorosulfonylphenyl)ethyltrichlorosilane, 2-(4-chlorosulfonyl-phenyl)ethyltrimethoxysilane, N-(trimethoxysilylpropyl)ethylenediamine triacetic acid, 2-cyanoethyltrimethoxysilane, 3-diethylphosphonatopropyltriethoxysilane, and 3-chloropropyltrimethoxysilane. After precipitating a sol-gel, processing is as described above.

This invention is not limited to materials with silica backbones. Inorganic backbone can also be formed with any covalently bonded inorganic oxides capable of forming oxygen linked network. These backbones may include, but are not limited to, titanium(IV) oxide (TiO₂), aluminum(III) oxide (Al₂O₃), zirconium(IV) oxide (ZrO₂), germanium(IV) oxide (GeO₂), gallium(III) oxide (Ga₂O₃), tin(IV) oxide (SnO₂), hafnium(IV) oxide (HfO₂), antimony(V) oxide (Sb₂O₅), niobium(V) oxide (Nb₂O₅), tantalum(V) oxide (Ta₂O₅) and combinations thereof. These inorganic oxides having a desired porosity and particle size can be prepared via various methods including, for example, sol gel, hydrothermal, Adams method, pyrolysis, decomposition of salts, etc.

If the oxide is made by a route that does not include a functionalized component, such as pyrolysis or Adam's method, it will need to be functionalized after the synthesis. These inorganic oxide particles can be functionalized with a suitable functional group such as, for example, —SH by reacting with a functionalized silane such as, for example, 3-mercaptopropyl-trimethoxy silane in the presence of an acid or base in an aqueous alcohol medium. In another variation functionalized silane may be added during the synthesis of the inorganic oxide particles to yield functionalized inorganic oxide particles. The —SH groups present on the inorganic oxide particles can be oxidized to obtain —SO₃H functionalized inorganic oxide particles.

Low surface area is a preferred characterization of the exchange sorbent particles for embodiments of the ²¹²Bi or ²¹³Bi generator of the present invention. A possible explanation may be, though not limiting the invention, that if the sorbent particles have a high surface area, much of the parent isotope deposits within the pores, which creates a longer diffusion path for the ²¹²Bi or ²¹³Bi to diffuse from the pores into the eluant. Product isotope that is generated from the parent isotope deposited deep within a pore will continue to decay while diffusing from the pore into the eluant stream, resulting in a loss of the generated ²¹²Bi or ²¹³Bi product and thereby, a lower product isotope yield. The hybrid organic-inorganic sulfonato-functionalized silica of a preferred embodiment of the present invention has a surface area less than about 200 m²/g. Preferably the surface area is less than about 10 m²/g and more preferably less than about 5 m²/g. The exchange sorbent of the present invention has been measured at less than about 0.7 m²/g.

An advantage of the exchange sorbent of the present invention is the long life of the material when exposed to strong radiation energy. Organic materials are heavily damaged by the radiation, such that the organic exchange sorbent used in current ²¹²Bi or ²¹³Bi generators is destroyed in a few days or weeks. Utilization of the exchange sorbent of the present invention provides a significantly longer life under the extreme radiation conditions of a ²¹²Bi or ²¹³Bi generator.

The exchange sorbent comprising the sulfonato-functionalized silica is loaded with the parent isotope, ²²⁵Ac or ^{224/225}Ra, so that the product isotope, ²¹²Bi or ²¹³Bi can “grow” on the exchange sorbent through the decay of the parent. Methods of loading the parent isotope onto the exchange sorbent are well known in the art. The exchange sorbent loaded with the parent isotope is held within an elutable container, such as a column or other suitable vessel for eluting the product isotope from the exchange sorbent. The ²²⁵Ac or ^{224/225}Ra may be loaded onto the ion exchange sorbent either before or after the exchange sorbent is placed into an elutable container. Elution can be accomplished with an eluting solution comprising about 0.01 to about 2 M acid. In one preferred process, the product isotope is eluted using a hydroiodic acid solution having a concentration of between about 0.05 M and 1 M to elute ²¹²Bi or ²¹³Bi as ²¹²BiI₅²⁻ or ²¹³BiI₅²⁻. Other acceptable eluants include, for example, mixtures of hydroiodic and hydrochloric acids, mixtures of hydroiodic acid and sodium chloride, and mixtures of hydrochloric acid and sodium iodide. The eluant may also contain antioxidants, such as ascorbic acid or gentisic acid (2,5-dihydroxybenzoic acid) with concentrations of between about 0.1 mg/mL to 100 mg/mL for preventing the discoloration of the column due to the oxidation of iodide.

The eluted acidic product isotope solution may be mixed with an appropriate buffer solution such as sodium acetate. Other suitable buffer solutions include, without limitation, potassium acetate, sodium hydroxide and potassium hydroxide. The buffer solution may also contain antioxidants, such as ascorbic acid or gentisic acid (2,5-dihydroxybenzoic acid), with concentrations of between about 0.1 mg/mL to 100 mg/mL. A preferred application of the product isotope is labeling antibodies or other biomolecules containing a chelator group that are useful for destroying cancer cells when the buffered solution containing the labeled antibodies or other biomolecules are injected or otherwise delivered into a patient.

The size of the sulfonato-functionalized silica particles used as the exchange sorbent in the generator is an important factor. The use of large particles of the exchange sorbent in a column provides low flow resistance of the eluant through the column but cannot be packed into a column or elutable container as densely as smaller particles may be packed. Furthermore, large particles create long diffusion paths over which the generated product isotope must travel while diffusing from the centers of the large particles. In contrast, fine particles of exchange sorbent permit more material to be packed into a column of a given volume and provide shorter diffusion paths out of the particles, but the fine particles produce greater flow resistance to the eluant during the elution of the product isotope from the generator.

Therefore, the ²¹²Bi or ²¹³Bi generator preferably includes smaller particles of the exchange sorbent because the shorter diffusion path allows the particles to equilibrate with the eluant more quickly and because the smaller particles pack more densely into a column of a given size. Both of these factors together promote the elution of product isotope using a small volume of the eluant and yield a high concentration of the product isotope in the eluate. Preferably, the particles of the exchange sorbent are made as small as possible without causing excessive back pressure from the flow of the eluant through the column. Preferably, but without limiting the invention, the size of the particles used in the generator may be between about 1 μm and about 1,000 μm. More preferably, the particle size of the exchange sorbent may be between about 25 and about 500 μm.

The column aspect ratio is also a factor that contributes to the optimum operation of the ²¹²Bi or ²¹³Bi generator of the present invention. The aspect ratio of a column is the column length over the column diameter. Increasing column length at constant diameter provides for greater retention of parent isotope and thereby minimizes the amount of leached parent isotope in the final eluate product. However, as the column length increases, total pressure drop across the column increases, causing higher back pressure at the inlet to the column. The column aspect ratio affects the properties of the generator even at constant column volume and exchange sorbent mass.

A long, narrow column having a high aspect ratio offers greater resistance to the flow of the eluant and generates a higher backpressure at the inlet to the column. Because the velocity of a given volume of eluant is higher in a column having a high aspect ratio, the flow through the column having a high aspect ratio is more turbulent, which increases mixing within the eluant stream. Comparatively, a short, wide column having a low aspect ratio operates with a lower velocity of a given volume of eluant through the column and operates at lower pressure drop with less mixing. However, channeling through the bed can occur at low velocities resulting in the eluant bypassing some of the exchange sorbent and providing a lower yield. While a wide range of column aspect ratios are acceptable, preferably, without limitation, the aspect ratio may be between about 2 and 40, more preferably between about 3 and about 10.

Preferably, the column or other elutable container is not loaded with uniform material over its entire length. The portion of the column closest to the generator's eluate outlet preferably holds ion exchange material containing no parent isotope, serving as a guard bed to intercept any parent isotope released from the upstream portion of the generator. By intercepting and capturing any released parent isotope, the product eluant is safe for use in radiomedicine as a ²¹²Bi or ²¹³Bi radioisotope. Alternatively, a guard bed may be placed in a second separate container, receiving the eluate from the outlet of the generator, to remove any parent isotope from the eluant eluted from the generator. Optionally, a guard bed may be installed in the generator as described above coupled with a separate filter containing ion exchange material as an added precaution.

Optionally, the functionalized species of the exchange sorbent may be supported on the surface of a non-porous support. Placing the exchange sorbent in a thin layer on a non-porous support provides the advantage of placing all of the exchange sorbent in close contact with the eluant, thereby minimizing the length of the diffusion path of the ²¹²Bi or ²¹³Bi from the exchange sorbent to the eluant. Suitable non-porous support materials include inorganic materials that are not damaged in a high radiation field, such as fiberglass, fine glass beads, ceramics, and other similar materials known to those skilled in the art. It is critical that any material chosen for this function does not release anything into the eluate that could contaminate the product.

In some embodiments of the present invention, the silica support forming the hybrid inorganic-organic exchange sorbent may be replaced, either totally or partially, with other species capable of forming an oxygen-linked network. Such exchange sorbents may include replacing some or all of the silicon in the support with, for example, aluminum, titanium, zirconium or combinations thereof.

### EXAMPLES

These Examples investigated the suitability of utilizing sulfonato-functionalized silica as an exchange sorbent in a ²²⁵Ac/²¹³Bi, ²²⁵Ra/²¹³Bi, or ²²⁴Ra²¹² Bi generator. Initial batch experiments compared the sulfonato-functionalized silica selectivities of a number of different samples with a commercially available organic resin currently used in ²¹³Bi generators, e.g., an acid cation exchange resin AG MP-50 sold by Bio-Rad Laboratories, Inc., having offices in Hercules, Calif. Column experiments were performed using surrogates.

### Example 1

### Synthesis of Exchange Sorbent Having About 25% Sulfonato-Functionalized Silica

A hybrid silica based exchange sorbent was synthesized by adding 37.5 mmoles of tetraethyl orthosilicate (TEOS) and 12.5 mmoles of 3-mercaptopropyltrimethoxy silane (MPTS) to a solution of 15 mL of 66% aqueous ethanol and 1 mL of 6N hydrochloric acid at room temperature. This quantity of MPTS provides an exchange sorbent having about 25% sulfonato-functionalized silica. The reaction mixture was vigorously shaken for two minutes and then the solvents were evaporated at 60° C. for three hours. Upon evaporation, a transparent glass product, thiol-functionalized silica, was obtained in quantitative yields (˜5 g).

An acid catalyzed reaction is preferred because it produces material with significantly lower surface area when compared to that of base catalyzed reaction with the same amount of thiol-functionalization as show in Table 1.

TABLE 1
BET specific surface area of some thiol-functionalized silica materials.

| | | | BET Specific |
|---|---|---|---|
| | TEOS:MPTS | | Surface Area |
| Sample | (Mole Ratio) | Catalyst | (m²/g) |
| B-5-1 | 95:5 | Base (5N NH₄OH) | 466.8 |
| B-20-2 | 80:20 | Base (5N NH₄OH) | 519.6 |
| B-30-6 | 70:30 | Base (5N NH₄OH) | 350.3 |
| A-20-1 | 80:20 | Acid (6N HCl) | 30.5 |
| HG-TS-7-SO3H | 60:20 | Acid (6N HCl) | 0.66 |

The thiol-functionalized silica was ground and sieved to produce particles of size 40×60 mesh (420 μm-250 μm). The particles were then washed with 0.05N hydrochloric acid and dried at 60° C. for three hours. The dried particles were suspended in 30% hydrogen peroxide (15 mL of H₂O₂ per gram of the thiol-functionalized silica) and then heated and slowly stirred at 100° C. for one hour to oxidize the thiol-functionalized silica to the sulfonato form.

The final product, sulfonato-functionalized silica, was washed with deionized water, 3N HCl and then again with deionized water. The exchange sorbent was then dried for three hours at 60° C.

Products produced using this method were labeled HG-TS-5-SO₃H and HG-TS-6-SO₃H. HG-TS-7-SO3H was synthesized using an identical procedure except that the reaction was scaled-up by a factor of two. In the synthesis of HG-TS-9-SO3H-II, HG-TS-10-SO3H-I and HG-TS-10-SO3H-II, the first step was scaled-up by a factor of ten. A BET specific surface area analysis of the final product (HG-TS-7-SO3H) was performed using krypton at −195.76° C. A surface area of 0.66 m²/g was obtained for the sample.

FIG. 2 shows a schematic for an exemplary synthesis of sulfonato-functionalized silica. Table 4 provides a summary of the reaction conditions and La³⁺ loading capacities of all the sulfonato-functionalized silica materials synthesized. It should be noted that La³⁺ is a surrogate for ²²⁵Ac which is normally present as the Ac³⁺ cation under these conditions.

### Example 2

### Synthesis of Exchange Sorbent Having About 10% Sulfonato-Functionalized Silica

The hybrid silica based exchange sorbent was synthesized using the same method as disclosed in Example 1 except for changing the ratio of the TEOS to MPTS to yield a 10% sulfonato-functionalized silica product. The exchange sorbent was synthesized by adding 450 mmoles of tetraethyl orthosilicate (TEOS) and 50 mmoles of 3-mercaptopropyltrimethoxy silane (MPTS) to a solution of 150 mL of 66% aqueous ethanol and 10 mL of 6N hydrochloric acid at room temperature. The reaction mixture was shaken vigorously for two minutes and then the solvents were evaporated at 60° C. for 15 hours. Upon evaporation, a transparent glass product, thiol-functionalized silica, was obtained in quantitative yield (46.2 g).

The thiol-functionalized silica was then suspended in 30% hydrogen peroxide (200 mL) and heated at 90° C. while slowly stirring for 20 minutes. The final product obtained, sulfonato-functionalized silica, was washed with DI water, then with 3N hydrochloric acid and then again with DI water. The exchange sorbent was then dried at 60° C. for 20 hours. The sulfonato-functionalized silica was ground and sieved to obtain particles of size 50×60 mesh (300 μm-250 μm) and 60×100 mesh (250 μm-150 μm), which were washed with 3N hydrochloric acid and dried at 60° C. for 48 hours. This material was labeled HG-A-10-1-SO₃H.

### Example 3

### Binding Affinity of Surrogates on the Sulfonato-Functionalized Silica

Binding affinities of both radioactive and non-radioactive surrogates for actinium, radium, lead and bismuth were determined by finding the distribution coefficients of simulates. Distribution Coefficients (K_{d} values) were determined according to the following Equation 1:
K_{d}=((Cᵢ−C_{f})/C_{f})*V/m (1)

where:
Cᵢ=initial activity (counts per minute (cpm)/mL) or concentration (ppm) in the solution
C_{f}=final activity (cpm/mL) or concentration (ppm) in the solution
V=volume of solution (mL)
m=mass of the exchange sorbent ion exchanger (g).

About 50 mg of the exchange sorbent made according to the procedure of Examples 1 and 2 was mixed, by shaking for 24 hours in a HDPE scintillation vial, with about 20 mL of solution containing either a radioactive or non-radioactive surrogate (˜4 ppm) for actinium, radium, lead or bismuth. The solution had a pH of about 2.0-2.5 and was made up of 0.1M NaNO₃ and the surrogate, although in some experiments, the NaNO₃ solution was replaced with 0.1M HCl/NaI solution. The surrogates were: Ba²⁺ for ^{224/225}Ra; La³⁺ and ⁸⁸Y³⁺ for ²²⁵Ac; and Bi³⁺ and ²⁰⁷Bi³⁺ for ^{212/213}Bi. After the mixing period, the exchange sorbent was separated from the solution by filtering through a 0.2 μm Whatman® Purdisc AS polyethersulfone membrane 25 mm syringe filter into a fresh HDPE scintillation vial.

The concentration of the surrogate in the filtered solution was determined by Inductively Coupled Plasma-Atomic Emissions Spectroscopy (ICP-AES) or atomic absorption spectroscopy (AAS) for La, Ba and Bi and a gamma counter for ⁸⁸Y and ²⁰⁷Bi. The results are shown in Tables 2 and 3.

TABLE 2
Distribution Coefficients (K_{d}) and Separation Factor of ⁸⁸Y and ²⁰⁷Bi

| | ⁸⁸Y K_{d} | ²⁰⁷Bi K_{d} | ⁸⁸Y/²⁰⁷Bi Separation |
|---|---|---|---|
| Sorbent Sample | (mL/g) | (mL/g) | Factor |
| HG-TS4-Sulfonato | 42 | 0.96 | 43.9 |
| HG-TS-6-SO₃H | 6717 | 0.30 | 22643 |
| HG-TS4-Sulfonato* | 1 | 6 | 0.16 |
| SiO2-40x60-HCl* | 0 | 5 | 0 |
| HG-TS-5-SO₃H | 27,410 | 0.07 | 397,340 |
| HG-TS-6-SO₃H | 29,741 | 0.53 | 55,278 |
| HG-TS-7-SO₃H | 77,254 | 0.07 | 1,176,831 |
| AG MP-50* | 433 | 4 | 113 |
| AG MP-50 | 4,012,412 | 57.00 | 70,205 |

*These experiments were performed in 0.1M HCl/0.1M NaI

TABLE 3
Distribution Coefficients (K_{d}) and Separation Factor of La and Bi

| | La K_{d} | Bi K_{d} | La/Bi |
|---|---|---|---|
| Sorbent Sample | (mL/g) | (mL/g) | Separation Factor |
| HG-TS-5-SO₃H | 78,182 | 11,180 | 7.0 |
| HG-TS-6-SO₃H | 94,406 | 9,849 | 9.8 |
| HG-TS-7-SO₃H | 153,459,169 | 36,504 | 4,204 |
| AG MP-50 | 158,909,355 | 26,970 | 5,892 |

Selectivity for Application in a ²²⁴Ra/²¹²Bi or ²²⁵Ra/²¹³Bi Generator

Selectivity was demonstrated by equilibrium uptake of Ba²⁺, Pb²⁺, and Bi³⁺ (surrogates for ^{224/225}Ra, ²¹²Pb, and ^{212/213}Bi respectively) in 0.1M NaI/0.1M HCl solution, which can be used for eluting ²¹²Bi from a ²²⁴Ra/²¹²Bi or ²²⁵Ra/²¹³Bi generator. Barium, lead, and bismuth were all quantified by ICP-AES. FIG. 4 shows binding affinity of the sulfonato-functionalized silica based ion exchange material for non-radioactive surrogates in 0.1M NaI/0.1M HCl.

Under these conditions, selectivities of >963 and >77 were obtained for Ba/Bi and Pb/Bi respectively, which are sufficient for use in a column separation. It is important to note that in these studies, Ba²⁺ and Pb²⁺ were dissolved in 0.1M NaI/0.1M HCl solution prior to contact with the ion exchanger. By contrast, in the operation of a typical bismuth generator, the parent (Ba²⁺ and Pb²⁺) is bound to the ion exchanger prior to the elution with 0.1M NaI/0.1M HCl solution to collect bismuth. There may be a difference in the measured selectivities of a generator having the parent bound to the exchange sorbent and those measured with the parent dissolved in solution prior to contact with the exchange sorbent. However, as seen bismuth affinity is expected to be low, especially in high halide (iodide) concentration media where the bismuth ions are expected to be present as an anionic halide (BiI₅²⁻) complex.

### Example 4

### Column Studies

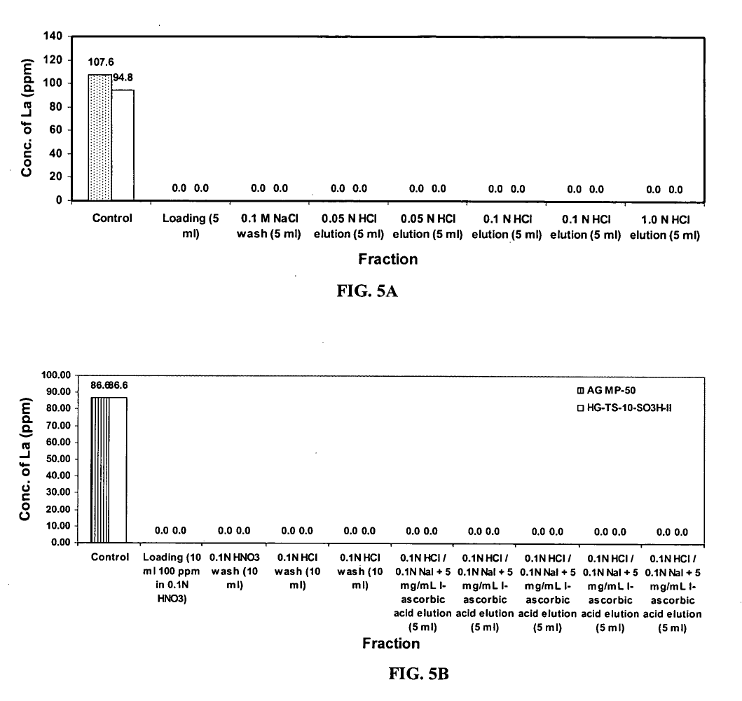

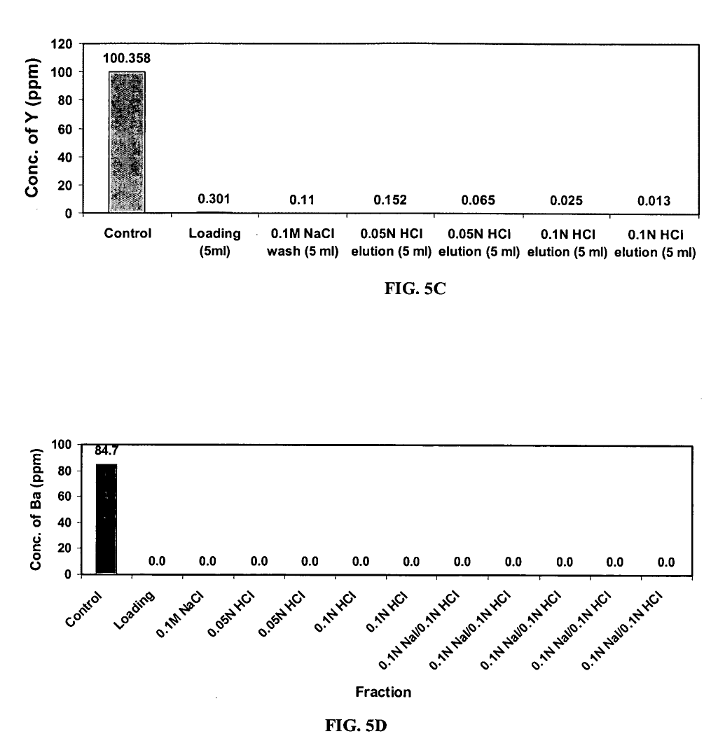

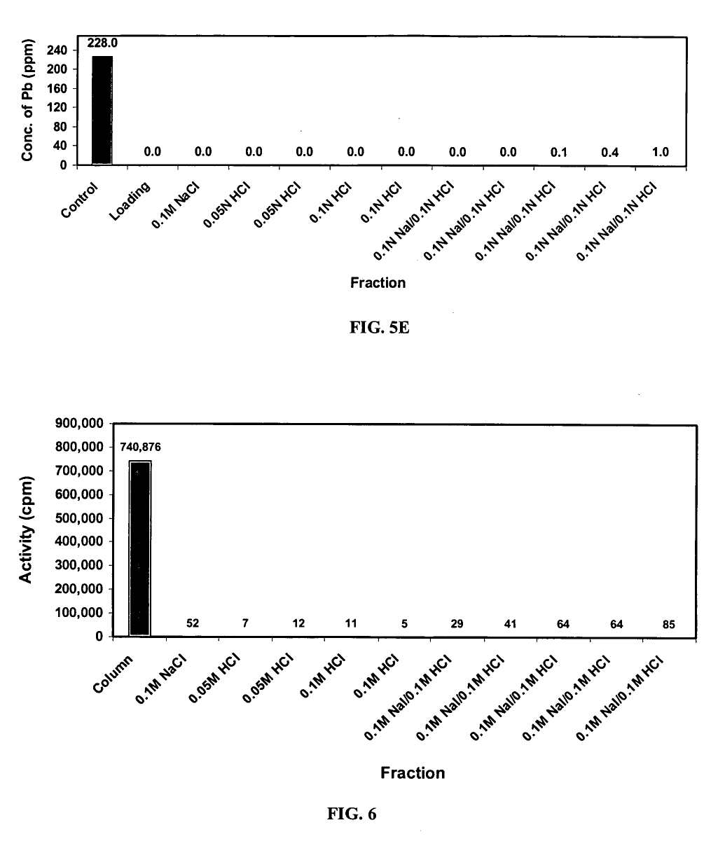

A column was loaded with 1 mL of exchange sorbent made according to the procedure of Example 1 or 2. A solution of the surrogates Y³⁺, La³⁺, Ba²⁺, or Pb²⁺ was prepared with a concentration of 100 ppm in 0.05N HCl (or 0.1N HNO₃). The column was run under gravity flow. After the column was loaded, the column was washed with 5 mL of 0.1 M NaCl (or once with 10 mL of 0.1N HNO₃ and twice with 10 mL of 0.1N HCl). Elution followed with 0.05N HCl (twice with 5 mL) and 0.1N HCl (twice with 5 mL) or 0.1N HCl containing 5 mg/mL I-ascorbic acid (five times with 10 mL). All fractions were collected and analyzed for Y³⁺, La³⁺, Ba²⁺, or Pb²⁺ using ICP-AES. These column studies demonstrated that Y³⁺, La³⁺, Ba²⁺ and Pb²⁺ can be loaded onto the exchange sorbent and does not breakthrough during elution when using the same eluent that is useful for eluting ²¹²Bi or ²¹³Bi from a ²²⁴Ra/²¹²Bi, ₂₂₅Ra/²¹³Bi, or ²²⁵Ac/²¹³Bi generator. The results are shown in FIGS. 5A-5E.

FIG. 5A provides the experimental results of a column study of AG MP-50 and HG-TS-10-SO₃H-I (1 mL BV) using gravity flow. A portion of the La³⁺ solution that is loaded on the column was used as a control.

FIG. 5B provides the experimental results of a column study of AG MP-50 and HG-TS-10-SO₃H-II (1 mL BV) using gravity flow. A portion of the La³⁺ solution that is loaded on the column was used as a control.

FIG. 5C provides the experimental results of a column study of HG-TS-7-SO₃H (1 mL BV) using gravity flow. A portion of the Y³⁺ solution that is loaded on the column was used as a control.

FIG. 5D provides the experimental results of a column study of HG-A-10-1-SO₃H (1 mL BV) using gravity flow. The volume of each fraction was 5 mL. A portion of the Ba²⁺ solution that is loaded on the column was used as a control.

FIG. 5E provides the experimental results of a column study of HG-A-10-1-SO₃H (1 mL BV) using gravity flow. The volume of each fraction was 5 mL. A portion of the Pb²⁺ solution that is loaded on the column was used as a control.

### Example 5

### Column Studies Using ²²³Ra

A column was loaded with 1 mL of exchange sorbent made according to the procedure of Example 2. An equilibrium solution (5 mL in deionized water) of ²²³Ra (surrogate for ^{224/225}Ra) with its decay daughters (²¹⁹Ra, ²¹⁵Po, ²¹¹Pb, ²¹¹Bi, ²⁰⁷Tl, and ²¹¹Po) was loaded onto the column. The column was run under gravity flow. After the column was loaded, it was washed five times with 5 mL of saline and set aside. It was washed 15 times again with 5 mL of saline on the next day. It was then eluted the following day with 0.1M NaCl (5 mL), 0.05M HCl (2×5 mL), 0.1M HCl (2×5 mL), and 0.1M NaI/0.1M HCl (5×5 mL). All fractions were collected and counted for activity on a gamma counter using the 154 keV emission of ²²³Ra and the 271 keV emission of ²¹⁹Ra and counting for 120 sec.

FIG. 6 provides the experimental results of the column study using HG-A-10-1-SO₃H (1 mL BV) as the exchange sorbent loaded with ²²³Ra and operated with gravity flow. Activity present on the column was calculated based on the activity loaded. This column study demonstrated that ^{224/225}Ra can be loaded onto the exchange sorbent and does not breakthrough during elution when using the same eluent that is useful for eluting ²¹²Bi or ²¹³Bi from a ²²⁴Ra/²¹²Bi, ²²⁵Ra/²¹³Bi, or ²²⁵Ac/²¹³Bi generator.

### Example 6

### La³⁺ Loading Capacity

The loading capacity of the actinium surrogate La³⁺ was determined by shaking a ˜100 mg specimen of exchange sorbent made according to the procedure of Example 1 and Example 2 with a solution containing about 2,000 ppm of La³⁺ in 0.05N HCl for about four hours. At the end of the four hour period, the exchange sorbent was separated from the solution and the concentration of the residual La³⁺ in the solution was measured using ICP-AES on a Varian® Liberty II ICP-OES spectrometer.

All samples were taken in duplicate and the results were averaged. The calculated loading capacities are shown in Table 4. The maximum loading capacity in mg of La per gram of sorbent material was calculated using the following equation:
Maximum Loading Capacity (mg/g)=(Cᵢ−Cₑ)*(V/m) (2)

where:
Cᵢ is the concentration of La in the initial solution in ppm;
Cₑ is the concentration of La at equilibrium in ppm;
m is the mass of the ion exchange material used in mg; and

V is the volume of the solution in mL.

TABLE 4
Maximum La³⁺ Loading Capacities

| | | | | | Oxidation | 30% H₂O₂ |
|---|---|---|---|---|---|---|
| | | Capacity | Capacity | | Time | Volume |
| Sample | % MPTS | (mmole/g) | (mg/g) | Buffer | (min) | (mL/g) |
| HG-TS-7-SO₃H | 25 | 0.42 | 57.81 | 0.1M NaNO₃ | 60 | 15 |
| AG MP-50 | — | 0.56 | 78.25 | 0.05N HCl | — | — |
| SiO₂ | — | 0.34 | 46.61 | 0.05N HCl | — | — |
| HG-TS-5-SO₃H | 25 | ND | ND | — | 60 | 15 |
| HG-TS-6-SO₃H | 25 | ND | ND | — | 60 | 15 |
| HG-TS-7-SO₃H | 25 | 0.46 | 64.47 | 0.05N HCl | 60 | 15 |
| HG-TS-8-SO₃H | 25 | 0.03 | 4.20 | 0.05N HCl | 120 | 15 |
| HG-TS-9-SO₃H-I | 25 | 0.00 | 0.00 | 0.05N HCl | 150 | 15 |
| HG-TS-9-SO₃H-II | 25 | 0.43 | 59.14 | 0.05N HCl | 50 | 15 |
| HG-TS-10-SO₃H-I | 25 | 0.82 | 114.40 | 0.05N HCl | 48 | 15 |
| HG-TS-10-SO₃H-II | 25 | 0.36 | 50.68 | 0.05N HCl | 48 | 15 |
| HG-TS-10-SO₃H-III | 25 | 0.50 | 70.06 | 0.05N HCl | 10 | 15 |
| HG-TS-10-SO₃H-IV | 25 | 0.70 | 97.21 | 0.05N HCl | 20 | 15 |
| HG-TS-10-SO₃H-V | 25 | 0.60 | 83.15 | 0.05N HCl | 30 | 15 |
| HG-TS-10-SO₃H-VI | 25 | 0.58 | 80.12 | 0.05N HCl | 40 | 15 |
| A-5-1 | 5 | 0.03 | 4.75 | 0.05N HCl | 20 | 5 |
| A-10-1 | 10 | 0.22 | 30.37 | 0.05N HCl | 20 | 5 |
| A-15-1 | 15 | 0.21 | 29.19 | 0.05N HCl | 20 | 5 |
| A-20-1 | 20 | 0.41 | 56.69 | 0.05N HCl | 20 | 5 |
| A-30-1 | 30 | 0.38 | 52.10 | 0.05N HCl | 20 | 5 |
| A-10-2 SO₃H | 10 | 0.09 | 13.01 | 0.05N HCl | 20 | 5 |
| A-20-2 SO₃H | 10 | 0.20 | 28.35 | 0.05N HCl | 20 | 5 |
| HG-TS-11-SO₃H | 25 | 0.14 | 19.96 | 0.05N HCl | 20 | 5 |
| HG-A-10-1-SO₃H-50 × 60 | 10 | 0.27 | 37.29 | 0.05N HCl | 20 | 5 |
| HG-A-10-1-SO₃H-60 × 100 | 10 | 0.29 | 40.36 | 0.05N HCl | 20 | 5 |
| AG MP-50 | — | 0.65 | 89.71 | 0.1M HNO₃ | — | — |
| HG-TS-11-SO₃H-VII | 25 | 0.60 | 82.90 | 0.1M HNO₃ | 20 | 15 |
| HG-TS-11-SO₃H-VIII | 25 | 0.55 | 76.57 | 0.1M HNO₃ | 20 | 5 |
| HG-TS-11-SO₃H | 25 | 0.46 | 64.19 | 0.1M HNO₃ | 20 | 5 |
| HG-TS-12-SO₃H | 25 | 0.45 | 62.44 | 0.1M HNO₃ | 27 | 1 |
| HG-TS-12-ozone-20 | 25 | 0 | 0 | 0.1M HNO₃ | 20 | — |
| HG-TS-12-ozone-40 | 25 | 0 | 0 | 0.1M HNO₃ | 40 | — |
| MW-A-9 | — | 0 | 0 | 0.05N HCl | — | — |
| MW-A-17 | — | 0 | 0 | 0.05N HCl | — | — |
| HG-1-40-25 | — | 0 | 0 | 0.05N HCl | — | — |

ND—Not determined.

### Example 7

### Effect of Oxidation Time During Synthesis of the Exchange Sorbent

The effect of the length of the oxidation step during the synthesis of the exchange sorbent was determined by making different batches of the exchange sorbent according to the procedure of Example 1 except that the duration of the oxidation step was varied for each of the batches. To determine the effect of the oxidation time on the exchange sorbent, loading capacities of the exchange sorbent were determined using the procedure of Example 6. The results are shown in Table 4.

As shown in Table 4, the amount of time taken for the oxidation step is critical. If not enough time is taken to oxidize the thiol functional groups to the sulfonic acid groups, then the exchange sorbent will not be as effective. However, if the oxidation step is too long, then the exchange sorbent quality drops as the oxidation of the exchange sorbent results in some of the sulfonic acid groups dissociating from the silica backbone. From the data shown in Table 4, it may be concluded that about 20 minutes is enough time to produce complete oxidation.

### Example 8

### Effect of H₂O₂ Quantity During Synthesis of the Exchange Sorbent

The effect of the H₂O₂ quantity used during the oxidation step during the synthesis of the exchange sorbent was determined by making different batches of the exchange sorbent according to the procedure of Example 1 except that the quantity of the 30% peroxide per mass unit of the exchange sorbent used in the oxidation step was varied for each of the batches. To determine the effect of H₂O₂ quantity used during the oxidation step on the exchange sorbent, loading capacities of the exchange sorbent were determined using the procedure of Example 6. The results are shown in Table 4. From this data, it may be concluded that about 5 mL of 30% H₂O₂ per gram of the thiol-functionalized silica is enough to yield the optimum oxidation.

### Example 9

### Synthesis of HG-TS-11-1-SO₃H

375 mmoles of tetraethyl orthosilicate (TEOS) and 125 mmoles of 3-mercaptopropyltrimethoxy silane (MPTS) to a solution of 150 mL of 66% aqueous ethanol and 10 mL of 6N HCl at room temperature. The reaction mixture was shaken vigorously for two minutes and then the solvents were evaporated at 60° C. for 15 hours. Upon evaporation, a transparent glass product, thiol-functionalized silica, was obtained in quantitative yield.

The thiol-functionalized silica was then suspended in 30% hydrogen peroxide (200 mL) and heated at 90° C., while slowly stirring, for 20 minutes. The final product, sulfonato-functionalized silica, was washed with DI water, then 3N HCl acid and followed by DI water and then dried at 60° C. for 20 hours. This example demonstrated that the synthesis of the exchange sorbent can be readily scaled up to produce larger batches of material.

### Example 10

### Synthesis of Sulfonato-Functionalized Aluminosilicate

Sulfonato-functionalized aluminosilicate can be synthesized by adding 225 mmoles of tetraethyl orthosilicate (TEOS), 225 mmoles of aluminum ethoxide, and 50 mmoles of 3-mercaptopropyltrimethoxy silane (MPTS) to a solution of 150 mL of 66% aqueous ethanol and 10 mL of 6N HCl at room temperature. The reaction mixture is shaken vigorously for about two minutes and then the solvents are evaporated, typically at 60° C. for about 15 hours. The thiol-functionalized aluminosilicate is then suspended in 30% hydrogen peroxide (200 mL) and heated at 90° C. while slowly stirring for 20 minutes.

The final product, sulfonato-functionalized aluminosilicate, is washed with DI water, then with 3N HCl and then again with DI water. The product is then dried, typically at 60° C. for about 20 hours. The sulfonato-functionalized aluminosilicate is ground and sieved to obtain particles that are about 50×60 and 60×100 mesh. These particles are then washed with 3N HCl and dried, typically at 60° C. for about 48 hours.

### Example 11

### Synthesis of Sulfonato-Functionalized Titanosilicate

Sulfonato-functionalized titanosilicate can be synthesized by adding 225 mmoles of tetraethyl orthosilicate (TEOS), 225 mmoles of titanium isopropoxide, and 50 mmoles of 3-mercaptopropyltrimethoxy silane (MPTS) to a solution of 150 mL of 66% aqueous ethanol and 10 mL of 6N HCl at room temperature. The reaction mixture is shaken vigorously for about two minutes and then the solvents are evaporated, typically at 60° C. for about 15 hours. The thiol-functionalized titanosilicate is then suspended in 30% hydrogen peroxide (200 mL) and heated at 90° C. while slowly stirring for 20 minutes.

The final product, sulfonato-functionalized titanosilicate, is washed with DI water, then with 3N HCl and then again with DI water. The product is then dried, typically at 60° C. for about 20 hours. The sulfonato-functionalized titanosilicate is ground and sieved to obtain particles that are about 50×60 and 60×100 mesh. These particles are then washed with 3N HCl and dried, typically at 60° C. for about 48 hours.

### Example 12

### Synthesis of Sulfonato-Functionalized Titanium Oxide

Titanium oxide is synthesized by hydrolysis of titanium isopropoxide. Briefly, by adding 450 mmoles of titanium isopropoxide to a solution of 150 mL of 66% aqueous ethanol and 10 mL of 6N HCl at room temperature. The reaction mixture is shaken vigorously for about two minutes and the solvents are evaporated, typically at 60° C. for about 15 hours. Titanium oxide particles thus obtained can be wetted by minimum amount of water and then added to a solution of 50 mmoles of 3-mercaptopropyltrimethoxy silane in 100 mL ethanol and reacted for about 4 hours at room temperature. The particles are then filtered and dried at 60° C. for about 15 hours. The thiol-functionalized titanium oxide is then suspended in 30% hydrogen peroxide (200 mL) and heated at 90° C. while slowly stirring for 20 minutes. The final product, sulfonato-functionalized titanium oxide, is washed with DI water, then with 3N HCl and then again with DI water. The product is then dried, typically at 60° C. for about 20 hours. The sulfonato-functionalized titanium oxide is ground and sieved to obtain particles that are about 50×60 and 60×100 mesh. These particles are then washed with 3N HCl and dried, typically at 60° C. for about 48 hours.

### Example 13

### Synthesis of Sulfonato-Functionalized Aluminum Oxide

Aluminum oxide can be synthesized by hydrolysis of aluminum ethoxide. Briefly, adding 450 mmoles of aluminum ethoxide to a solution of 150 mL of 66% aqueous ethanol and 10 mL of 6N HCl at room temperature. The reaction mixture is shaken vigorously for about two minutes and then the solvents are evaporated, typically at 60° C. for about 15 hours. Aluminum oxide particles thus obtained can be wetted by a minimum amount of water and then added to a solution of 50 mmoles of 3-mercaptopropyltrimethoxy silane in 100 mL ethanol and reacted for about 4 hours at room temperature. The particles are then filtered and dried at 60° C. for about 15 hours. The thiol-functionalized aluminum oxide is then suspended in 30% hydrogen peroxide (200 mL) and heated at 90° C. while slowly stirring for 20 minutes. The final product, sulfonato-functionalized aluminum oxide, is washed with DI water, then with 3N HCl and then again with DI water. The product is then dried, typically at 60° C. for about 20 hours. The sulfonato-functionalized aluminum oxide is ground and sieved to obtain particles that are about 50×60 and 60×100 mesh. These particles are then washed with 3N HCl and dried, typically at 60° C. for about 48 hours.

### Example 14

### Another Synthesis of Sulfonato-Functionalized Aluminum Oxide

Aluminum oxide can be synthesized by hydrolysis of aluminum ethoxide. Briefly, by adding 450 mmoles of aluminum ethoxide to a solution of 150 mL of 66% aqueous ethanol and 10 mL of 6N HCl at room temperature. The reaction mixture is shaken vigorously for about two minutes and then the solvents are evaporated, typically at 60° C. for about 15 hours. Aluminum oxide particles thus obtained can be wetted by minimum amount of water, suspended in ethanol, and then added to a solution of 50 mmoles of 3-mercaptopropyldiethoxyaluminum in 100 mL ethanol and reacted for about 4 hours at room temperature. The particles are then filtered and dried at 60° C. for about 15 hours. The thiol-functionalized aluminum oxide is then suspended in 30% hydrogen peroxide (200 mL) and heated at 90° C. while slowly stirring for 20 minutes. The final product, sulfonato-functionalized aluminum oxide, is washed with DI water, then with 3N HCl and then again with DI water. The product is then dried, typically at 60° C. for about 20 hours. The sulfonato-functionalized aluminum oxide is ground and sieved to obtain particles that are about 50×60 and 60×100 mesh. These particles are then washed with 3N HCl and dried, typically at 60° C. for about 48 hours.

### Example 15

### Synthesis of Ion Exchange Sorbent Utilizing Sulfonic Acid

A hybrid silica based exchange sorbent is synthesized by adding 37.5 mmoles of tetraethyl orthosilicate (TEOS) and 12.5 mmoles of 3-(trihydroxysilyl)-1-propanesulfonic acid to a solution of 15 mL of 66% aqueous ethanol and 1 mL of 6N hydrochloric acid at room temperature. This quantity of sulfonic acid provides an exchange sorbent having about 25% sulfonato-functionalized silica. The reaction mixture was vigorously shaken for two minutes and then the solvents were evaporated at 60° C. for three hours. Upon evaporation, a transparent glass product, sulfonato-functionalized silica, is obtained in quantitative yields.

It will be understood from the foregoing description that various modifications and changes may be made in the preferred embodiment of the present invention, including the addition of components to the solutions passing through the generator to optimize the eluant for specific applications, without departing from its true spirit. It is intended that this description is for purposes of illustration only and should not be construed in a limiting sense. The scope of this invention should be limited only by the language of the following claims.

What is claimed is:

1. A radionuclide product generator, comprising:
an ion exchange sorbent comprising oxygen-containing functional groups grafted by organic linking groups to an inorganic oxygen-linked network, wherein the exchange sorbent has a surface area of less than about 100 m²/g.

2. The generator of claim 1, wherein the inorganic oxygen-linked network comprises oxides of aluminum, titanium, silica, zirconium, hafnium, tantalum, niobium, germanium, gallium, tin, antimony or combinations thereof.

3. The generator of claim 1, wherein the inorganic oxygen-linked network comprises silica.

4. The generator of claim 1, wherein the surface area is less than about 10 m²/g.

5. The generator of claim 1, wherein the surface area is less than about 1 m²/g.

6. The generator of claim 1, wherein the oxygen-containing functional groups comprise sulfonato groups.

7. The generator of claim 1, wherein the functional groups comprise moieties selected from —SO₃H, —SO₃Na, —SO₃K, —SO₃Li, —SO₃NH₄ or combinations thereof.

8. The generator of claim 1, wherein the functional groups comprise moieties selected from —PO(OX)₂, —COOX or combinations thereof, wherein X is selected from H, Na, K, NH₄ or combinations thereof.

9. The generator of claim 1, wherein the ion exchange sorbent is amorphous.

10. The generator of claim 1, wherein the linking groups are an organic moiety.

11. The generator of claim 10, wherein the linking groups are an organic chain having between about 1 and about 10 carbon atoms.

12. The generator of claim 10, wherein the groups are an organic chain having between about two and about four carbon atoms.

13. The generator of claim 1, wherein the exchange sorbent is functionalized between about 1 and about 80 percent.

14. The generator of claim 1, wherein the exchange sorbent is functionalized between about 1 and about 25 percent.

15. The generator of claim 1, wherein particles of the exchange sorbent are between about 75 μm and about 150 μm in diameter.

16. The generator of claim 1, further comprising:
a parent isotope adsorbed onto the exchange sorbent, wherein the parent isotope is selected from ²²⁴Ra or ²²⁵Ra.

17. The generator of claim 1, further comprising:
a parent isotope adsorbed onto the exchange sorbent, wherein the parent isotope comprises ²²⁵Ac.

18. A ²¹³Bi generation process, comprising:
eluting an eluate solution of ²¹³Bi with an aqueous solvent from a generator, the generator comprising ²²⁵Ac or ²²⁵Ra on a support medium, wherein the support medium is an exchange sorbent comprising oxygen-containing functional groups grafted by organic linking groups to an inorganic oxygen-linked network and wherein the exchange sorbent has a surface area of less than about 100 m²/g.

19. The process of claim 18, wherein the inorganic oxygen-linked network comprises silicates.

20. The process of claim 18, wherein the inorganic oxygen-linked network comprises oxides of aluminum, titanium, silica, zirconium, hafnium, tantalum, niobium, germanium, gallium, tin, antimony or combinations thereof.

21. The process of claim 18, wherein the exchange sorbent is functionalized between about 1 and about 90 percent.

22. The process of claim 18, wherein the oxygen-containing functional groups are selected from —SO₃H, —SO₃Na, —SO₃K, —SO₃Li, —SO₃NH₄ or combinations thereof.

23. The process of claim 18, wherein the oxygen-containing functional groups are selected from —PO(OX)₂, —COOX or combinations thereof, and wherein X is selected from H, Li, Na, K, NH₄ or combinations thereof.

24. The process of claim 18, wherein the aqueous solvent comprises an aqueous acid having a concentration between about 0.01 M and about 2 M.

25. The process of claim 24, wherein the aqueous solvent comprises an aqueous acid having a concentration of between about 0.1 M and about 0.5 M.

26. The process of claim 18, wherein the aqueous solvent comprises an aqueous acid selected from HCl, HI, HBr or combinations thereof.

27. The process of claim 18, wherein the aqueous solvent comprises HI having a concentration of between about 0.1 M and 0.5 M.

28. The process of claim 18, wherein the surface area is less than about 10 m²/g.

29. The process of claim 18, wherein the surface area is less than about 1 m²/g.

30. A ²¹²Bi generation process, comprising:
eluting an eluate solution of ²¹²Bi with an aqueous solvent from a generator, the generator comprising ²²⁴Ra on a support medium, wherein the support medium is an exchange sorbent comprising oxygen-containing functional groups grafted by organic linking groups to an inorganic oxygen-linked network and wherein the exchange sorbent has a surface area of less than about 100 m²/g.

31. The process of claim 30, wherein the inorganic oxygen-linked species comprises silicates and oxides of aluminum, titanium, zirconium, hafnium, tantalum, niobium, germanium, gallium, tin, antimony or combinations thereof.

32. The process of claim 30, wherein the inorganic oxygen-linked network comprises silica.

33. The process of claim 30, wherein the surface area is less than about 10 m²/g.

34. A method of making a radionuclide generator for ²¹²Bi or ²¹³Bi, comprising:
loading an isotope that is a parent to ²¹²Bi or ²¹³Bi onto an exchange sorbent that comprises oxygen-containing functional groups grafted by organic linking groups to an inorganic oxygen-linked network, wherein the exchange sorbent has a surface area of less than about 100 m²/g.

35. The method of claim 34, wherein the parent isotope is ²²⁵Ac.

36. The method of claim 34, wherein the parent isotope is selected from ²²⁵Ra or ²²⁴Ra.

37. The method of claim 34, further comprising steps for synthesizing the exchange sorbent comprising:
combining an inorganic species with a functionalized silane in a solution comprising an alcohol and an acid to form a reaction mixture;
mixing the reaction mixture;
evaporating the reaction mixture to recover a functionalized inorganic oxygen-linked network product;
oxidizing the functional groups.

38. The method of claim 37, wherein the inorganic species comprises a silicate.

39. The method of claim 37, wherein the inorganic species comprises oxides of aluminum, titanium, zirconium, silica, hafnium, tantalum, niobium, germanium, gallium, tin, antimony or combinations thereof.

40. The method of claim 37, wherein the inorganic species is selected from an aluminate, a titanate, a zirconate, hafnate, tantalate, niobate, germanate, gallate, stannate, antimonate or combinations thereof.

41. The method of claim 34, wherein the surface area is less than about 10 m²/g.

42. The method of claim 37, wherein the moles of functionalized silane in the reaction mixture is between about 1% and about 80% of the total moles of the functionalized silane and the inorganic species.

43. The method of claim 37, wherein the moles of functionalized silane in the reaction mixture is between about 5% and about 25% of the total moles of the functionalized silane and the inorganic species.

44. The method of claim 37, wherein the acid is selected from HCl, HNO₃, H₂SO₄, HBr, HI or combinations thereof.

45. The method of claim 37, wherein the alcohol is selected from ethanol, butanol, propanol, isopropanol, isomers of butanol or combinations thereof.

46. The method of claim 37, wherein the functionalized silane is 3-mercaptopropyltrimethoxy silane.

47. The method of claim 36, wherein the oxygen containing functional groups are selected from —SO₃H, —SO₃Na, —SO₃K, —SO₃Li, —SO₃NH₄ or combinations thereof.

48. The method of claim 36, wherein the oxidized functional groups are selected from —PO(OX)₂ or —COOX, and wherein X is selected from H, Li, Na, K, NH₄ or combinations thereof.

49. The method of claim 34, further comprising steps for synthesizing the exchange sorbent comprising:
combining an alkoxide-containing inorganic species with a silicon-containing thiol in a solution comprising an alcohol and a mineral acid to form a reaction mixture;
mixing the reaction mixture;
evaporating the reaction mixture to recover a functionalized inorganic oxygen-linked network product; and
oxidizing the functional groups.

50. The method of claim 34, further comprising steps for synthesizing the exchange sorbent comprising:
combining an alkoxide-containing inorganic species with a silicon-containing thiol in a solution comprising an alcohol and a base to form a reaction mixture;
mixing the reaction mixture;
evaporating the reaction mixture to recover a functionalized inorganic oxygen-linked network product; and
oxidizing the functional groups.

51. The method of claim 50 where the base is ammonium hydroxide.

52. The method of claim 34, further comprising steps for synthesizing the exchange sorbent comprising:
combining an alkoxide containing inorganic species with a silicon-containing sulphonic acid in a solution comprising an alcohol to form a reaction mixture;
mixing the reaction mixture; and
evaporating the reaction mixture to recover a functionalized inorganic oxygen-linked network product.

53. The method of claim 52, wherein the solution of the reaction mixture further comprises a mineral acid.
